(19) United States
(12) Patent Application Publication
(10) Pub. No.: US 2007/0223397 A1
(43) Pub. Date: Sep. 27, 2007

(54) Network configuration

(76) Inventors: Sergey Gerasimov, El Cerrito, CA (US); Clay E. Olsen, Roseville, CA (US); Marc A. Sordi, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/388,470

(22) Filed: Mar. 24, 2006

(51) Int. Cl. H04L 12/28; H04L 12/56

(52) U.S. Cl. 370/254; 370/409

(57) ABSTRACT

Where a manual protocol address for a computing device has been stored, the manual protocol address is acquired. Stateless network configuration for the computing device is performance in accordance with a protocol. Stateful network configuration for the computing device is performed in accordance with a policy for the protocol and in accordance with one or more managed configuration flags for the stateful network configuration. The policy for the protocol at least partially conflicts with the managed configuration flags for the stateful network configuration.

### BACKGROUND

Network resources, such as web servers hosting web sites, are typically accessible over the Internet by network addresses. For example, in accordance with the Internet Protocol (IP) version four, commonly referred to as IPv4, a network address at which a network resource is accessible is given as a.b.c.d, where each of a, b, c, and d is an integer between 0 and 255. As another. example, in accordance with the IP version six, commonly referred to as IPv6, a network address is given as a:b:c:d:e:f:g:h, where each of a, b, c, d, e, f, g, and h is a hexadecimal number from 0x0000 to 0xFFFF. A given network resource may be accessible by an IPv4 address, by one or more IPv6 addresses, or by both an IPv4 address and one or more IPv6 addresses.

Historically, network resources were accessible over the Internet via IPv4 network addresses only. However, for a variety of reasons, including primarily the concern that the number of unique IPv4 network addresses was running out, addressing is being slowly transitioned to IPv6 network addresses, such that network resources will each ultimately become accessible by one or more IPv6 network addresses. Network configuration of a computing device is more complicated with respect to IPv6 network addresses as compared to IPv4 network addresses.

For instance, generally a computing device has just one IPv4 network address. However, a computing device may have more than one IPv6 network address, such as a so-called stateless address received from routing device like a router, one or more so-called stateful addresses received via a dynamic host configuration protocol (DHCP) server, as well as a manually assigned address and a so-called link local address. Therefore, when a computing device is to communicate with other devices on an IPv6-addressable network, it needs to perform a network configuration process in order to receive or otherwise be assigned one or more IPv6 network addresses.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated.

FIG. 1 is a diagram of a system, according to an embodiment of the invention.

FIG. 2 is a flowchart of a method for performing network configuration, according to an embodiment of the invention.

FIGS. 3A and 3B are tables of a stateful network configuration policy and managed configuration values, according to an embodiment of the invention.

FIG. 4 is a flowchart of a method for performing stateful network configuration, according to an embodiment of the invention.

FIG. 5 is a block diagram of a computing device, according to an embodiment of the invention.

### DETAILED DESCRIPTION OF THE DRAWINGS

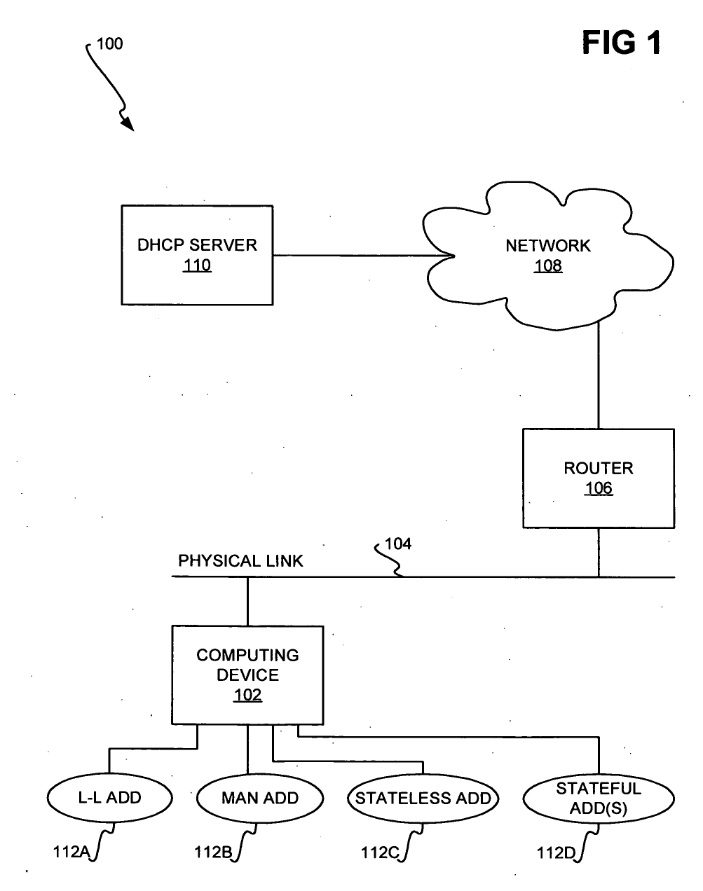

FIG. 1 shows a system 100, according to an embodiment of the invention. A computing device 102 is physically located on a local physical link 104 that is connected to a larger network 108 via a router 106. The computing device 102 may be any type of electronic device that has networking capability, such as laptop and desktop computers, printing devices with networking capability, imaging devices such as scanners that also have networking capability, and so on. The physical link 104 is a local network segment that directly connects one or more devices, such as the computing device 102. The router 106, which is more generally a routing device, allows the devices on the physical link 104 to communicate with devices on the network 108, such as the dynamic host configuration protocol (DHCP) server 110.

The network 108, including the physical link 104, is addressable in accordance with a given protocol. More particularly, resources on the network 108 are addressable in accordance with a given protocol. In one embodiment, the network 108 is an Internet Protocol (IP) version six, or IPv6, network, in which network resources are each addressable via one or more network addresses each given as a:b:c:d:e:f:g:h, where each of a, b, c, d, e, f, g, and h is a hexadecimal number from 0x0000 to 0xFFFF.

The computing device 102, as representative of all resources on the network 108, thus may have four different types of IPv6 addresses, which are also referred to as protocol addresses or network addresses herein. First, the computing device 102 has a so-called link local address 112A. The link local address 112A is used by the computing device 102 to communicate with other devices on the same physical link 104. Data packets sent over the physical link 104 associated with link local addresses are not forwarded by the router 106 to the network 108, since they are intended for local receipt by other devices on the physical link 104. The terminology “link local address” is used herein consistent with the usage of this terminology as known to those of ordinary skill within the art.

Second, the computing device 102 may have a manual address 112B. The manual address 112B is an address that the computing device 102 is assigned manually. More particularly, the manual address 112B is an address that a user may enter on a user interface of the computing device 102. As compared to other addresses of the computing device 102, as will be described, the manual address 112B is not received from another device on the network in accordance with an automatic configuration process, but rather is manually assigned to the computing device 102.

Third, the computing device 102 may have a so-called stateless address 112C. The stateless address 112C is an address that is received in accordance with a protocol, such as IPv6, from a routing device, like the router 106. That is, the computing device 102 performs stateless network configuration in accordance with a protocol in order to receive the stateless address 112C from a routing device, as is described in more detail later in the detailed description. The terminology “stateless address” and “stateless network configuration” is employed herein consistent with the usage of this terminology as known to those of ordinary skill within the art.

Fourth, the computing device 102 may have one or more stateful addresses 112D. Each of the stateful addresses 112D is an address that is received from a DHCP server, like the DHCP server 110. The stateful addresses 112D are received by the computing device 102 performing stateful network configuration in accordance with a policy for a protocol, such as a DHCP policy, and in accordance with one or more managed configuration flags for the stateful network configuration, as is described in more detail later in the detailed description. In at least some embodiments, as will be described, the policy for the protocol at least partially conflicts with the managed configuration flags for the stateful network configuration. The terminology “stateful address” and “stateful network configuration” is employed herein consistent with the usage of this terminology as known to those of ordinary skill within the art.

Embodiments of the invention are concerned with performing network configuration of the computing device 102, so that it receives or acquires one or more network or protocol addresses in order for the computing device 102 to communicate with other devices and other types of network resources. Such network configuration can thus result in the computing device 102 receiving or being assigned one or more of the addresses 112A, 112B, 112C, and 112D that have been described. Furthermore, some embodiments of the invention are concerned with the particular DHCP policy in accordance with which stateful network configuration is achieved.

It is noted that the network topology depicted in FIG. 1 is for example purposes only, and other embodiments of the invention may be employed in relation to other network topologies. For instance, the DHCP server 110 may be located on the physical link 104, instead of on the network 108. Furthermore, the router 106 may not be present.

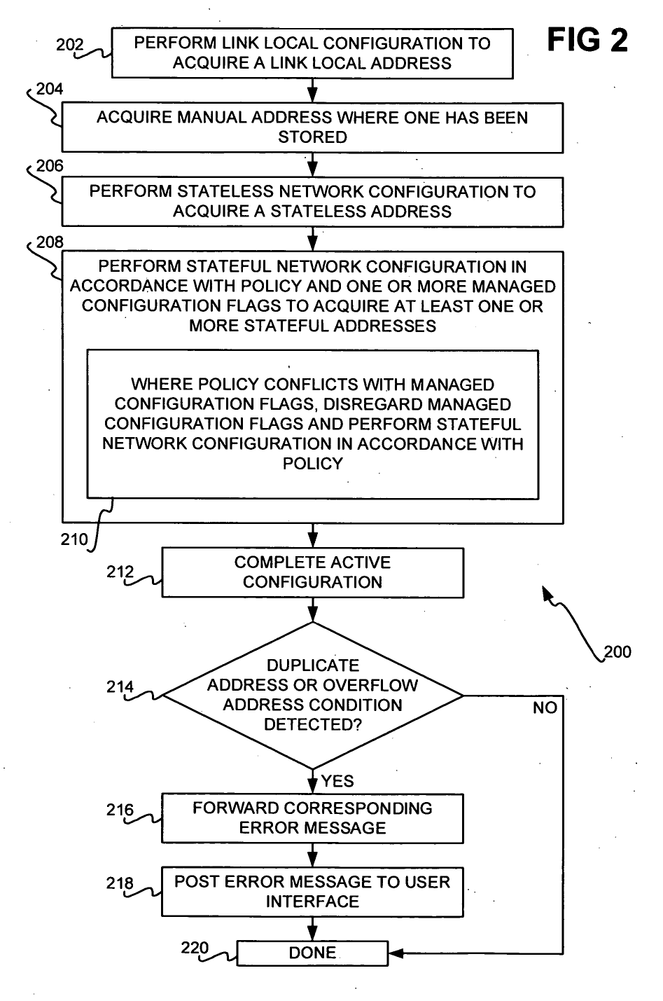

FIG. 2 shows a method 200 that is performable by the computing device 102 to achieve network configuration in accordance with a protocol, such as IPv6, according to an embodiment of the invention. The method 200 is performed by the computing device 102 in order for the computing device 102 to acquire one or more of the network addresses 112A, 112B, 112C, and 112D that have been described. The steps or acts of the method 200 may be performed in the order indicated in FIG. 2. The method 200 may further be performed during the startup of the computing device 102, in a synchronous or asynchronous manner.

First, a link local protocol configuration is performed for the computing device 102 to acquire the link local address 112A (202). In one embodiment, the link local protocol configuration is performed as is standard in accordance with IPv6. Next, where the manual address 112B has been previously stored within the computing device 102, it is acquired (204). In one embodiment, the manual address 112B is further acquired only if the computing device 102 is in an active state, which means that a manual address is to be employed in relation to the computing device 102, as opposed to an address being automatically assigned ot the computing device 102.

Thereafter, the computing device 102 may perform stateless network configuration to acquire the stateless address 112C from the router 106 or another routing device (206). In one embodiment, the stateless network configuration is performed as is standard in accordance with IPv6. Therefore, the stateless address 112C may be acquired only if the router 106 is appropriately configured to provide the stateless address 112C to the computing device 102. Otherwise, no stateless address may be acquired by the computing device 102. Furthermore, one or more managed configuration flags may be received as part of the stateless network configuration, where such flags are employed in conjunction with performing stateful network configuration.

The computing device 102 thus then performs stateful network configuration to acquire at least the stateful addresses 112D (208). Stateful network configuration is performed in accordance with the one or more managed configuration flags, such as is standard in conjunction with IPv6, as may have been received in relation to the stateless network configuration, and also in accordance with a stateful network configuration policy, such as a DHCP policy, as is described in more detail later in the detailed description. In one embodiment, however, the policy at least partially conflicts with the managed configuration flags. Thus, where the policy-does conflict with the managed configuration flags, the computing device 102 disregards these flags and instead performs stateful network configuration only in accordance with the policy (210). This is also described in more detail later in the detailed description.

It is noted that in one embodiment, the managed configuration flags are received from a routing device, as part of the stateless network configuration, as has been described, whereas the stateful network configuration policy itself is set as part of the configuration process of the computing device 102 itself. It is also noted that the stateful network configuration may be performed in an asynchronous manner. For example, the stateful network configuration may be performed in response to a request received from the router 106 or another routing device to perform such stateful configuration. In another embodiment, the stateful network configuration may be performed in a synchronous manner, in order after part 206 has been performed.

Performance of the stateful network configuration may result in the computing device 102 acquiring other information in addition to the stateful addresses 112D. For instance, the network address of a gateway device, such as a gateway server, for use by the computing device 102 to communicate with other device on the network 108, may be acquired. As another example, the network address of the DNS server 110 may be also be received, for communicative use by the computing device 102.

Thereafter, the computing device 102 completes active network configuration (212), where the computing device 102 is in an active state. Completion of the active configuration can include performing any other processes needed by the computing device 102 to reach a ready state where it can be used, as can be appreciated by those of ordinary skill within the art.

Network configuration of the computing device 102 can result in errors occurring. For instance, there may be duplicate addresses within the addresses 112A, 112B, 112C, and 112D, which is generally not allowed or otherwise undesirable within IPv6, among other types of networking protocols. As another example, an overflow address condition may occur, which is acquiring more addresses than can be stored in local memory.

Where either type of error is detected (214), the corresponding error message is forwarded to an error-logging device, such as an error-logging server (216). Furthermore, the error message is posted to a user interface of the computing device 102 itself (218), so that a user of the device 102 is able to review the error message. The method 200 is then finished (220), and is also finished where no error is detected in part 214, such that parts 216 and 218 are not performed. It is noted that while parts 214, 216, and 218 are depicted as being performed after parts 202, 204, 206, and 208 are performed, in another embodiment, these parts are performed after each of the parts 202, 204, 206, and 208 is performed. That is, the various errors are detected after each of these parts is performed.

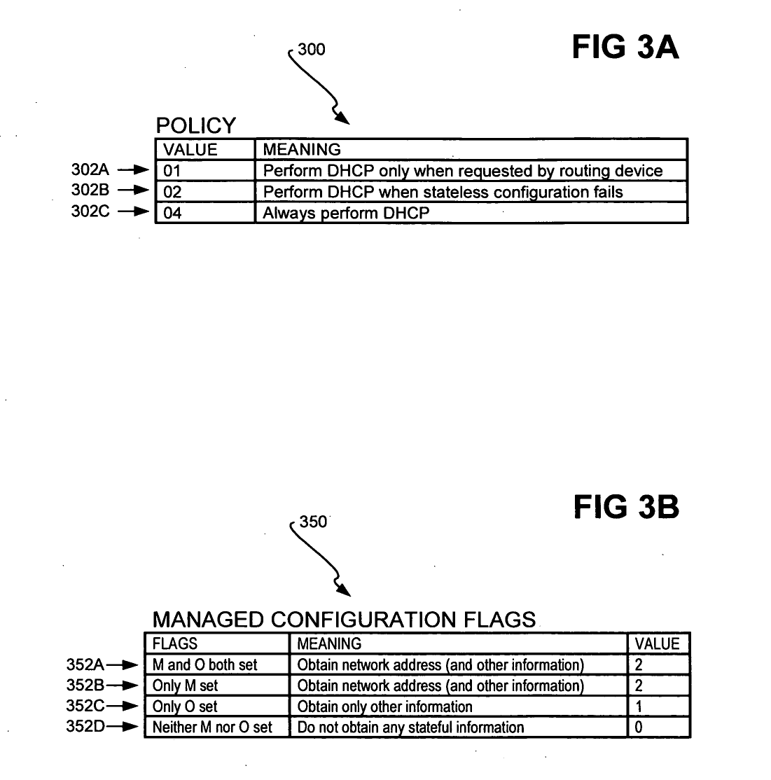

As has been described, in one embodiment the stateful network configuration of part 208 is performed by the computing device 102 to obtain at least the stateful addresses 112D, in accordance with a policy for the protocol in question and in accordance with one or more managed configuration flags. FIG. 3A shows a table 300 depicting this policy, according to one embodiment of the invention. The value for the policy may be set to one of three different values, as desired by the user or network administrator, corresponding to the rows 302A, 302B, and 302C of the table 300. As has been described, the policy can be set within a device configuration process of the computing device 102.

If the value for the policy is 1, corresponding to the row 302A of the table 300, then DHCP is performed only when requested by a routing device. That is, the computing device 102 performs stateful network configuration to obtain at least the stateful addresses 112D by performing DHCP in relation to a DHCP server, such as the server 110, only when a routing device, such as the router 106 requests that the device 102 do so, as specified by one or more managed configuration flags, as will be described in more detail in relation to FIG. 3B. As a result, DHCP and thus stateful network configuration may be considered as being performed asynchronously, since they are performed only if a routing device requests that they be performed.

If the value for the policy is 2, corresponding to the row 302B of the table 300, then DHCP is performed only when the stateless network configuration of part 206 of the method 200 fails. That is, the computing device 102 first attempts to perform the stateless network configuration in part 206 of the method 200. If such configuration is unsuccessful, in that the stateless address 112C was not obtained from a routing device like the router 106, then the computing device 102 performs stateful network configuration to obtain at least the stateful addresses 112D by performing DHCP in relation to a DHCP server.

Finally, if the value for the policy is 4, corresponding to the row 302C of the table 300, then DHCP is always performed. Therefore, it does not matter whether a routing device has not requested that DHCP be performed, nor whether the stateless network configuration has been performed. Rather, stateful network configuration is always performed by the computing device 102, to obtain at least the stateful addresses 112D by performing DHCP in relation to a DHCP server.

FIG. 3B shows a table 350 depicting the different values that two managed configuration flags in particular can take on, and their meaning, as may be used by an embodiment of the invention. The two managed configuration flags are referred to as an M flag and an O flag, and their values and meaning are defined in the Request For Comment (RFC) 2461 document available from the Internet Engineering Task Force at the Internet web site www.ieff.org. There are four different combinations of values that the flags may take on, as desired by the user or network administrator, corresponding to the rows 352A, 352B, 352C, and 352D of the table 350. As has been noted, the configuration flags can be received from a routing device in accordance with a stateless configuration process.

If both the M and the O flags are set, corresponding to the row 352A of the table 350, then a stateful network address, as well as other information, such as gateway and DNS server network address information, are acquired by the computing device 102. That is, the computing device 102 performs complete stateful network configuration, by, for instance, performing DHCP in relation to a DHCP server, like the DHCP server 110. Similarly, if only the M flag is set, corresponding to the row 352B of the table 350, then a stateful network address and other information are acquired by the computing device 102. Because the meanings of both the M and the O flags being set and of just the M flag being set are the same, the value for either such situation can be considered the same, which is denoted as 2 in the table 350 of FIG. 2B.

If just the O flag is set, corresponding to the row 352C of the table 350, then only the other information, such as gateway and DNS server network address information, is acquired by the computing device 102, and no stateful network addresses are obtained. That is, the computing device 102 performs partial stateful network configuration, by, for instance, partially performing DHCP in relation to a DHCP server. In this situation, then, the stateful addresses 112D are not obtained by the computing device 102. The value for this situation is denoted as 1 in the table 350 of FIG. 2B.

Finally, if neither the M flag nor the O flag is set, corresponding to row 352D of the table 350, then no stateful information is obtained. That is, the computing device 102 does not perform DHCP in relation to a DHCP server, does not obtain the stateful addresses 112D, and does not obtain gateway and DNS server network address information. No stateful network configuration is performed. The value for this situation is denoted as 0 in the table 350 of FIG. 2B.

Performing stateful network configuration in accordance with the policy of FIG. 3A as well as in accordance with the managed configuration flags of FIG. 3B is advantageous. This is because performing stateful network configuration in accordance with the managed configuration flags ensures that the computing device 102 is performing such configuration consistently with IPv6 standards. However, performing stateful network configuration also in accordance with a DHCP policy is also desirable to provide a user or a network administrator more control over the stateful network configuration process than is possible using the managed configuration flags alone.

It is noted, however, that the policy of FIG. 3A at least partially conflicts with the managed configuration flags of FIG. 3B. For instance, where the policy has a value of 4, corresponding to the row 302C of the table 300 of FIG. 3A, and where the managed configuration flags have a value of 1 or 0, corresponding to the row 352C or 352D of the table 350 of FIG. 3B, there is a conflict as to how to perform stateful network configuration. In particular, the policy having a value of 4 indicates that DHCP, and thus stateful network configuration, should always be performed. However, the managed configuration flags having a value of 1 indicates that DHCP should only partially be performed, such that no stateful network addresses should be obtained. Similarly, the managed configuration flags having a value of 0 indicates that DHCP not be performed at all.

In such instances, the policy of FIG. 3A overrides the managed configuration flags of FIG. 3B, and stateful network configuration is completely and fully performed, by performing DHCP. In other words, the value of the managed configuration flags is disregarded. In such cases where the policy conflicts with the managed configuration flags, then, the policy is controlling, and the managed configuration flags are not. It is noted that the policy of FIG. 3A is also applicable where no managed configuration flags, such as those of FIG. 3B, have been received, which is the case, for instance, where there is no routing device, such as router 106 of FIG. 1.

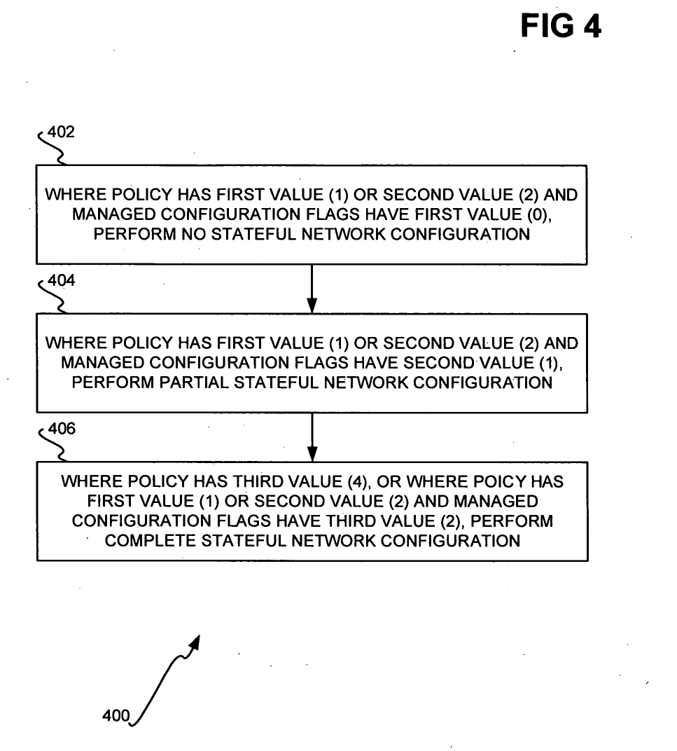

FIG. 4 shows a method 400 for performing the stateful network configuration of part 208 of the method 200 of FIG. 2, consistent with the policy of FIG. 3A and the managed configuration flags of FIG. 3B, according to an embodiment of the invention. Thus, where the policy has a first value of 1 or a second value of 2, and the managed configuration flags have a first value of 0, then no stateful network configuration is performed (402). That is, no stateful network addresses are obtained by the computing device 102, and no other information, such as a gateway network address and a DNS server network address, is obtained.

By comparison, where the policy has the first value of 1 or the second value of 2, and the managed configuration flags have a second value of 1, then partial stateful network configuration is performed (404). In particular, information other than stateful network addresses, such as a gateway network address and a DNS server network address, are obtained. Stateful network addresses are not obtained by the computing device 102, however.

Finally, where the policy has a third value of 4, or where the policy has the first value of 1 or the second value of 2 and the managed configuration flags have a third value of 2, then complete stateful network configuration is performed (406). That is, stateful network addresses are obtained, via performing DHCP, as well as gateway and DNS server network addresses. It is noted that part 406 includes the situation where the policy conflicts with the managed configuration flags. In particular, where the policy has the third value of 4, and the managed configuration flags have the first value of 0 or the second value of 1 (i.e., a value other than the third value of 2), there is a conflict between the policy and the managed configuration flags. This is why it is stated that complete network configuration is performed where the policy has the third value of 4, without regards to the value of the managed configuration flags, since DHCP is always performed in this case, regardless of the value of the managed configuration flags.

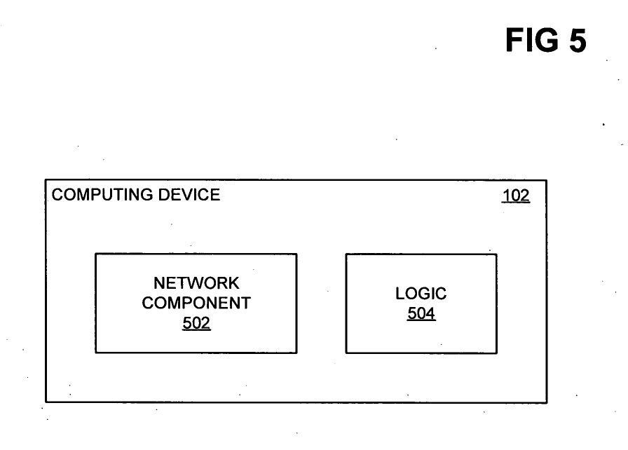

FIG. 5 shows the computing device 102 in more detail, according to an embodiment of the invention. In particular, the computing device 102 is shown as including a network component 502 and logic 504. As can be appreciated by those of ordinary skill within the art, the computing device 102 can and typically does include other components, in addition to those shown in FIG. 5.

The network component 502 is to communicatively connect the device 102 to a network, such as the physical link 104 of the network 108, and may be an Ethernet wired or wireless network adapter, or another type of network component. The logic 504 may be implemented in software, firmware, and/or hardware. The logic 504 is to perform the network configuration that has been described, such as that of the method 200 of FIG. 2 and/or that of the method 400 of FIG. 4.

We claim:

1. A method comprising:
where a manual protocol address for a computing device has been stored, acquiring the manual protocol address for the computing device;
performing stateless network configuration for the computing device in accordance with a protocol; and,
performing stateful network configuration for the computing device in accordance with a policy for the protocol and in accordance with one or more managed configuration flags for the stateful network configuration,
wherein the policy for the protocol at least partially conflicts with the managed configuration flags for the stateful network configuration.

2. The method of claim 1, wherein the protocol is Internet Protocol (IP) version six (IPv6).

3. The method of claim 1, further comprising initially performing a link local protocol configuration for the computing device, resulting in the computing device acquiring a link local protocol address.

4. The method of claim 1, further comprising completing an active configuration for the computing device.

5. The method of claim 1, wherein the manual protocol address for the computing device is acquired where the computing device is an active state, in addition to where the manual protocol address has been stored.

6. The method of claim 1, wherein performing the stateless network configuration for the computing device comprises acquiring a stateless protocol address for the computing device.

7. The method of claim 1, wherein performing the stateless network configuration for the computing device comprises performing the stateless network configuration in response to receiving a request from a routing device.

8. The method of claim 1, wherein performing the stateful network configuration for the computing device comprises acquiring at least one of:
a stateful protocol address for the computing device;
a network address of a gateway for communicative use by the computing device; and,
a network address of a domain name system (DNS) server for communicative use by the computing device.

9. The method of claim 1, wherein performing the stateful network configuration for the computing device comprises performing the stateful network configuration in response to receiving a request, such that the stateful network configuration is performed in an asynchronous manner.

10. The method of claim 1, wherein performing the stateful network configuration for the computing device in accordance with the policy for the protocol comprises performing the stateful network configuration in accordance with a dynamic host configuration protocol (DHCP) policy.

11. The method of claim 1, wherein performance of the method results in acquiring at least one of:
a link local protocol address for the computing device;
the manual protocol address for the computing device;
a stateless protocol address for the computing device; and,
a stateful protocol address for the computing device.

12. The method of claim 11, further comprising, upon detecting a duplicate address within the link local protocol address, the manual protocol address, the stateless protocol address, and the stateful protocol address, at least one of:
forwarding a corresponding error message to an error-logging device; and,
posting the corresponding error message to a user interface.

13. The method of claim 11, further comprising, upon detecting an overflow address condition, at least one of:
forwarding a corresponding error message to an error-logging device; and,
posting the corresponding error message to a user interface.

14. A method for performing stateful network configuration for a computing device in accordance with a policy for a protocol and in accordance with one or more managed configuration flags for the stateful network configuration, comprising:
where the policy for the protocol has a first value or a second value and the managed configuration flags have a first value, performing no stateful network configuration for the computing device;
where the policy for the protocol has the first value or the second value and the managed configuration flags have a second value, not acquiring a stateful protocol address for the computing device, and acquiring at least one of:
a network address of a gateway for communicative use by the computing device; and,
a network address of a domain name system (DNS) server for communicative use by the computing device; and,
where the policy for the protocol has a third value, or where the policy for the protocol has the first value or the second value and the managed configuration flags have a third value, acquiring at least one of the stateful protocol address for the computing device, the network address of the gateway, and the network address of the DNS server.

15. The method of claim 14, wherein the protocol is Internet Protocol (IP) version six (IPv6).

16. The method of claim 14, wherein:
the first value of the policy for the protocol specifies that a dynamic host configuration protocol (DHCP) is to be performed upon request by a routing device;
the second value of the policy for the protocol specifies that the DHCP is to be performed upon failure of a stateless network configuration for the computing device; and,
the third value of the policy for the protocol specifies that the DHCP is always to be performed.

17. The method of claim 14, wherein:
the first value of the managed configuration flags specifies that the stateful network configuration for the computing device is not to be performed;
the second value of the managed configuration flags specifies that the network addresses of the gateway and the DNS server are to be acquired and that the stateful protocol address for the computing device is not to be acquired; and,
the third value of the managed configuration flags specifies that the network addresses of the gateway and the DNS server and the stateful protocol address for the computing device are to be acquired.

18. The method of claim 14, further comprising initially:
where a manual protocol address for the computing device has been stored, acquiring the manual protocol address for the computing device; and,
performing stateless network configuration for the computing device in accordance with the protocol.

19. The method of claim 18, further comprising initially performing a link local protocol configuration for the computing device, resulting in the computing device acquiring a link local protocol address.

20. A computing device comprising:
a network component to communicatively connect the computing device to a network; and,
means for performing stateless network configuration for the computing device in accordance with a protocol, and for performing stateful network configuration for the computing device in accordance with a policy for the protocol and in accordance with one or more managed configuration flags for the stateful network configuration,
wherein the policy for the protocol has one of a plurality of values comprising:
a first value specifying that a dynamic host configuration protocol (DHCP) is to be performed upon request by a routing device;
a second value specifying that the DHCP is to be performed upon failure of a stateless network configuration for the computing device; and,
a third value specifying that the DHCP is always to be performed.
